(19) United States
(12) Patent Application Publication
(10) Pub. No.: US 2013/0111486 A1
(43) Pub. Date: May 2, 2013

(54) APPARATUS AND METHOD FOR EXCLUSIVE CONTROL

(71) Applicant: Fujitsu Limited, Kawasaki (JP)

(72) Inventors: Hiroshi Sada, Kawasaki (JP); Tatsuhiro Souda, Yokohama (JP)

(73) Assignee: FUJITSU LIMITED, Kawasaki (JP)

(21) Appl. No.: 13/665,228

(22) Filed: Oct. 31, 2012

(30) Foreign Application Priority Data
Nov. 1, 2011 (JP) 2011-240595

(51) Int. Cl. G06F 9/46

(52) U.S. Cl. 718/102

(57) ABSTRACT

An apparatus performs a plurality of processes, and determines content of I/O processing requested by an I/O processing request that has been issued, by one of the plurality of processes, to access common resources including a plurality of devices shared by the plurality of processes. The apparatus causes the I/O processing request to acquire one of first and second access authorities depending on the determined content of the I/O processing, where the first access authority permits only one I/O processing request at a time to access the common resources, and the second access authority permits only one I/O processing request at a time to access one of the plurality of devices included in the common resource.

### CROSS-REFERENCE TO RELATED APPLICATION

This application is based upon and claims the benefit of priority of the prior Japanese Patent Application No. 2011-240595, filed on Nov. 1, 2011, the entire contents of which are incorporated herein by reference.

### FIELD

The embodiments discussed herein are related to an apparatus and method for exclusive control.

### BACKGROUND

In general multiprocessor systems which execute a plurality of processes, a giant lock method in which a kernel of an OS (Operating System) is subjected to exclusive control by a single lock and execution of an I/O (Input Output) process on common resources is controlled has been widely used.

Hereinafter, an OS which employs such a giant lock method will be described as an example.

FIG. 9 is a diagram illustrating an example of an OS which employs a giant lock method. FIG. 9 illustrates a hardware layer including devices A to C serving as common resources shared by a plurality of processes, an OS layer which issues an I/O process to the devices A to C, and a user space where a user program for issuing a request for performing the I/O process is executed.

Furthermore, in the example of FIG. 9, the OS includes an I/O process reception unit 41, an I/O processing unit 42, and a giant lock control unit 43 in a kernel. Here, the I/O processing unit 42 includes an I/O issuance processing unit 42a, a device recognition processing unit 42b, and an error processing unit 42c. Furthermore, the giant lock control unit 43 includes a check unit 43a, a determination unit 43b, and an acquisition unit 43c.

When a user program issues a request for performing an I/O process (hereinafter, will be also expressed as “an I/O process request) relative to the devices A to C, the I/O process reception unit 41 assigns the I/O process request to one of the I/O issuance processing unit 42a, the device recognition processing unit 42b, and the error processing unit 42c included in the I/O processing unit 42 in accordance with content of the I/O process. For example, the I/O process reception unit 41 assigns a request for performing an I/O issuance process for executing the I/O process to the I/O issuance processing unit 42a and a request for performing an device recognition process for recognition of the devices A to C to the device recognition processing unit 42b. Furthermore, the I/O process reception unit 41 assigns a request for performing an error process for errors generated in the devices A to C to the error processing unit 42c.

The I/O issuance processing unit 42a requests the giant lock control unit 43 to acquire an exclusive lock regarding all the devices A to C when receiving the request for performing the I/O issuance process assigned thereto from the I/O process reception unit 41. Furthermore, the I/O issuance processing unit 42a executes the I/O issuance process after acquiring the exclusive lock, and releases the acquired exclusive lock when the I/O issuance process is terminated.

Moreover, as with the I/O issuance processing unit 42a, each of the device recognition processing unit 42b and the error processing unit 42c requests the giant lock control unit 43 to acquire an exclusive lock upon receiving the corresponding request assigned thereto. Then each of the device recognition processing unit 42b and the error processing unit 42c executes various I/O processes after the exclusive lock is acquired, and releases the acquired exclusive lock when the I/O processes are terminated.

The check unit 43a checks states of the exclusive locks acquired by the I/O issuance processing unit 42a, the device recognition processing unit 42b, and the error processing unit 42c when one of the I/O issuance processing unit 42a, the device recognition processing unit 42b, and the error processing unit 42c requests acquisition of the exclusive lock. Furthermore, the determination unit 43b determines whether any one of the I/O issuance processing unit 42a, the device recognition processing unit 42b, and the error processing unit 42c has acquired an exclusive lock. Thereafter, when the determination unit 43b determines that none of the I/O issuance processing unit 42a, the device recognition processing unit 42b, and the error processing unit 42c have acquired an exclusive lock, the acquisition unit 43c causes the one of the I/O issuance processing unit 42a, the device recognition processing unit 42b, and the error processing unit 42c to acquire an exclusive lock.

On the other hand, when the determination unit 43b determines that another one of the I/O issuance processing unit 42a, the device recognition processing unit 42b, and the error processing unit 42c acquires an exclusive lock, the acquisition unit 43c causes the one of the I/O issuance processing unit 42a, the device recognition processing unit 42b, and the error processing unit 42c to suspend acquisition of an exclusive lock for a predetermined time period. Thereafter, when the exclusive lock is released and the determination unit 43b determines that none of the I/O issuance processing unit 42a, the device recognition processing unit 42b, and the error processing unit 42c have acquired an exclusive lock, the acquisition unit 43c causes one of the I/O issuance processing unit 42a, the device recognition processing unit 42b, and the error processing unit 42c which has requested acquisition of an exclusive lock to acquire an exclusive lock.

Hereinafter, an example of a process executed by the OS when a user program issues a request X for requesting execution of the I/O issuance process regarding the device A and a request Y for requesting execution of the device recognition process will be described. For example, the I/O process reception unit 41 assigns the request X to the I/O issuance processing unit 42a when the user program issues the request X for requesting execution of the I/O issuance process relative to the device A.

In this case, the I/O issuance processing unit 42a requests the giant lock control unit 43 to acquire an exclusive lock. Then the giant lock control unit 43 allows the I/O issuance processing unit 42a to acquire an exclusive lock since none of the I/O issuance processing unit 42a, the device recognition processing unit 42b, and the error processing unit 42c have acquired an exclusive lock. Then, the I/O issuance processing unit 42a executes the I/O issuance process relative to the device A.

Subsequently, the I/O process reception unit 41 assigns the request Y for requesting execution of the device recognition process to the device recognition processing unit 42b. In this case, the device recognition processing unit 42b requests the giant lock control unit 43 to acquire an exclusive lock. Then the giant lock control unit 43 causes the device recognition processing unit 42b to suspend acquisition of an exclusive lock for a predetermined time period since the I/O issuance processing unit 42a has already acquired the exclusive lock.

Thereafter, the I/O issuance processing unit 42a releases the exclusive lock when the I/O issuance process relative to the device A is terminated. Then the giant lock control unit 43 allows the device recognition processing unit 42b to acquire an exclusive lock since none of the I/O issuance processing unit 42a, the device recognition processing unit 42b, and the error processing unit 42c has acquired an exclusive lock. Then the device recognition processing unit 42b executes the device recognition process.

The related art is disclosed in Japanese Laid-open Patent Publication No. 2011-118688, for example.

### SUMMARY

According to an aspect of the invention, an apparatus determines content of I/O processing requested by an I/O processing request that has been issued, by one of a plurality of processes, to access common resources including a plurality of devices shared by the plurality of processes. The apparatus causes the I/O processing request to acquire one of first and second access authorities depending on the determined content of the I/O processing, where the first access authority permits only one I/O processing request at a time to access the common resources, and the second access authority permits only one I/O processing request at a time to access one of the plurality of devices included in the common resource.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an exclusive control program, according to a first embodiment;

FIG. 2 is a diagram illustrating an example of a transition of lock acquisition states, according to an embodiment;

FIG. 3 is a diagram illustrating an example of assignment of an I/O process request, according to an embodiment;

FIG. 4 is a diagram illustrating an example of transition of a lock acquisition state, according to an embodiment;

FIG. 5 is a diagram illustrating an example of transition of a lock acquisition state, according to an embodiment;

FIG. 6 is a diagram illustrating an example of an operational flowchart for a request assigning process, according to a first embodiment;

FIG. 7 is a diagram illustrating an example of an operational flowchart for acquiring a device-basis exclusive lock, according to a first embodiment;

FIG. 8 is a diagram illustrating an example of an operational flowchart for obtaining a batch exclusive process, according to a first embodiment; and

FIG. 9 is a diagram illustrating an example of an OS which employs a giant lock method.

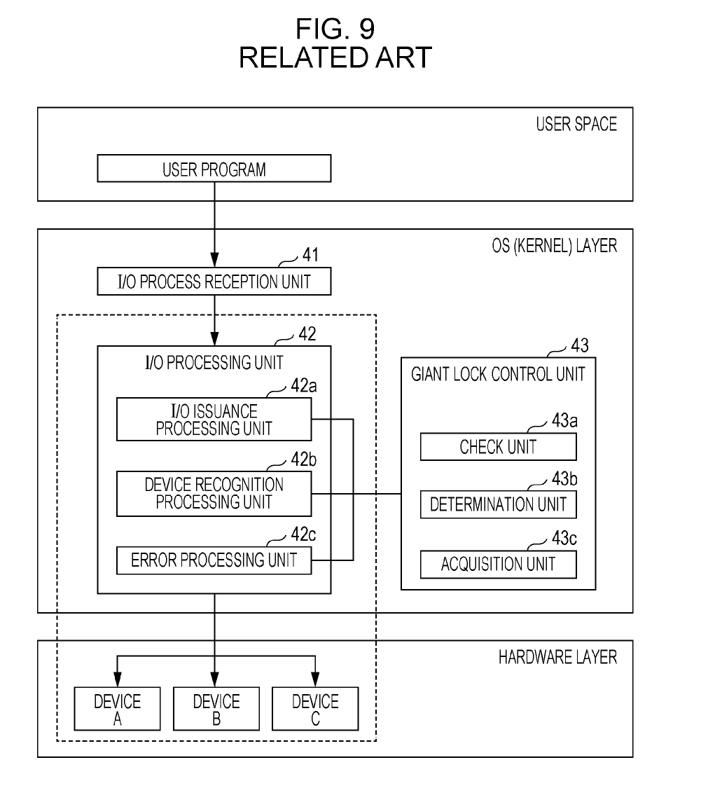

### DESCRIPTION OF EMBODIMENTS

There arises a problem in that a plurality of I/O processes are not allowed to be executed in parallel in the giant lock technique described above since an exclusive lock of all the common resources is collectively acquired for one I/O process. Therefore, when a plurality of processes are executed in parallel in a case where, for example, a multiprocessor technique is employed I/O, processes are not allowed to be executed in parallel, and therefore, system performance may not be improved.

Hereinafter, an exclusive control program, an exclusive control apparatus, and an exclusive control method according to this application will be described with reference to the accompanying drawings.

### First Embodiment

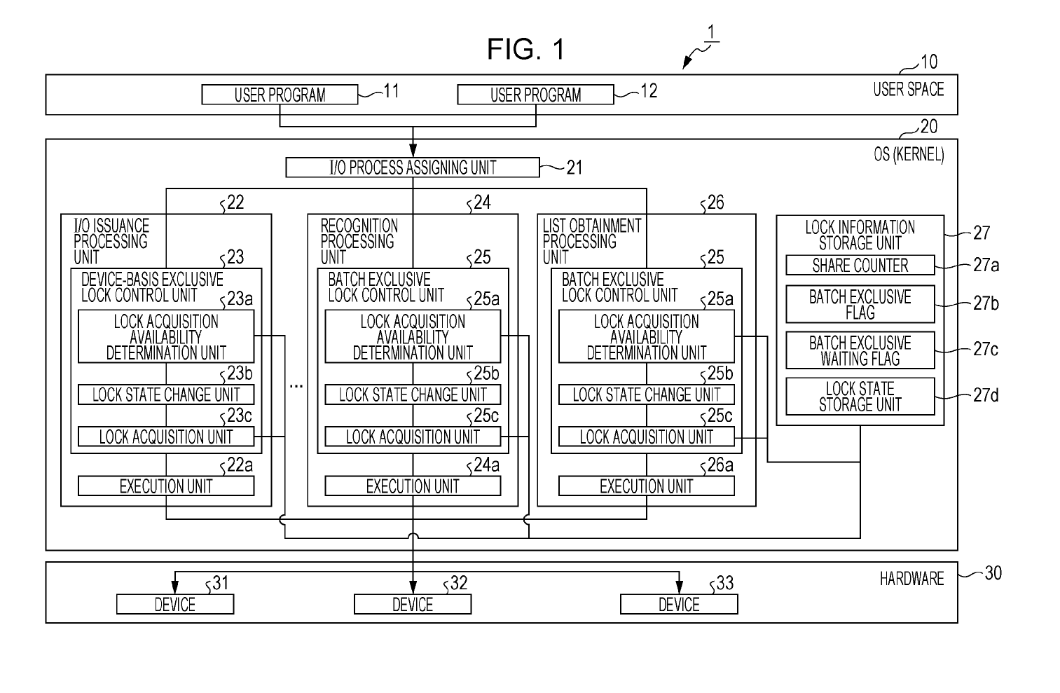

In a first embodiment described hereinafter, an example of an exclusive control program which is executed by an information processing apparatus which employs a multiprocessor technique will be described with reference to FIG. 1.

FIG. 1 is a diagram illustrating an example of exclusive control program, according to a first embodiment. In the example of FIG. 1, it is assumed that the exclusive control program is executed as part of an OS 20.

FIG. 1 illustrates programs to be executed in a user space 10, programs executed as the OS (kernel) 20, and hardware 30 serving as common resources shared by the programs, in a layered manner.

For example, in the example illustrated in FIG. 1, the information processing apparatus 1 executes a plurality of user programs 11 and 12 in the user space 10, and the OS 20. Further, the hardware 30 includes a plurality of devices 31 to 33 shared by the user programs 11 and 12. Here, the devices 31 to 33 may be hardware such as disk devices.

The OS 20 includes an I/O (Input Output) processing assigning unit 21, an I/O issuance processing unit 22, a recognition processing unit 24, a list obtainment processing unit 26, and a lock information storage unit 27. The I/O issuance processing unit 22 includes a device-basis exclusive lock control unit 23 and an execution unit 22a. The recognition processing unit 24 includes a batch exclusive lock control unit 25 and an execution unit 24a. The list obtainment processing unit 26 includes a batch exclusive lock control unit 25 and an execution unit 26a. The lock information storage unit 27 includes a share counter 27a, a batch exclusive flag 27b, a batch exclusive waiting flag 27c, and a lock state storage unit 27d.

Further, the device-basis exclusive lock control unit 23 includes a lock acquisition availability determination unit 23a, a lock state change unit 23b, and a lock acquisition unit 23c. The batch exclusive lock control unit 25 includes a lock acquisition availability determination unit 25a, a lock state change unit 25b, and a lock acquisition unit 25c.

The I/O issuance processing unit 22 executes an I/O process relative to one of the devices 31 to 33, and the recognition processing unit 24 recognizes devices included in the hardware 30. The list obtainment processing unit 26 generates a list of the devices included in the hardware 30.

The OS 20 may include a plurality of other processing units in addition to the I/O issuance processing unit 22, the recognition processing unit 24, and the list obtainment processing unit 26 illustrated in FIG. 1. For example, the OS 20 may include an error processing unit which executes a process for recovery from an error in the devices 31 to 33. Further, the OS 20 may include an I/O interruption processing unit which executes an arbitrary interruption process when a process is performed for a certain device. In this way, the OS 20 may include a plurality of processing units which execute respective specific I/O processes for the devices 31 to 33.

The I/O issuance processing unit 22, the recognition processing unit 24, and the list obtainment processing unit 26 each acquire, as an access authority, a first or second access authority. The first access authority indicates a batch exclusive lock which allows only one of the I/O issuance processing unit 22, the recognition processing unit 24, and the list obtainment processing unit 26 to access all the devices 31 to 33, in other words, a giant lock. The second access authority indicates a device-basis exclusive lock which allows only one of the I/O issuance processing unit 22, the recognition processing unit 24, and the list obtainment processing unit 26 to access one of the devices 31 to 33. Here, the I/O issuance processing unit 22, the recognition processing unit 24, and the list obtainment processing unit 26 each acquire, as the second access authority, a shared lock which permits a plurality of processing units (in this case, the I/O issuance processing unit 22, the recognition processing unit 24, and the list obtainment processing unit 26) to access one of the devices 31 to 33, together with the above mentioned device-basis exclusive lock.

For example, the I/O issuance processing unit 22 includes a device-basis exclusive lock control unit 23 which acquires the device-basis exclusive lock. Further, each of the recognition processing unit 24 and the list obtainment processing unit 26 includes the batch exclusive lock control unit 25 which acquires the batch exclusive lock. Then each of the I/O issuance processing unit 22, the recognition processing unit 24, and the list obtainment processing unit 26 acquires the requested access authority using the device-basis exclusive lock control unit 23 or the batch exclusive lock control unit 25.

In the example illustrated in FIG. 1, a case where each of a plurality of processing units (for example, the I/O issuance processing unit 22, the recognition processing unit 24, and the list obtainment processing unit 26) has the device-basis exclusive lock control unit 23 or the batch exclusive lock control unit 25 is described. However, each of the plurality of processing units may employ a method for calling the device-basis exclusive lock control unit 23 or the batch exclusive lock control unit 25 as a subroutine, depending on a type of an I/O process to be executed.

Next, a process executed by the I/O process assigning unit 21 will be described. When one of the user programs 11 and 12 issues a request for performing an I/O process (an I/O process request), the I/O process assigning unit 21 determines content of the requested I/O process. Thereafter, the I/O process assigning unit 21 assigns the I/O process request to one of the I/O issuance processing unit 22, the recognition processing unit 24, and the list obtainment processing unit 26 which is to execute the determined content of the I/O process.

For example, when the user program 11 or the user program 12 issues a request for performing an I/O issuance process, the I/O process assigning unit 21 assigns the request to the I/O issuance processing unit 22. When the user program 11 or the user program 12 issues a request for performing a process of recognizing the devices 31 to 33 included in the hardware 30, the I/O process assigning unit 21 assigns the request to the recognition processing unit 24. When the user program 11 or the user program 12 issues a request for performing a process of obtaining a list of devices included in the hardware 30, the I/O process assigning unit 21 assigns the request to the list obtainment processing unit 26.

Next, the lock information storage unit 27 will be described. The share counter 27a counts the number of shared locks acquired by the device-basis exclusive lock control unit 23. For example, when the device-basis exclusive lock control unit 23 acquires two shared locks, the share counter 27a stores value “2” as the number of acquired shared locks. The batch exclusive flag 27b represents whether the batch exclusive lock control unit 25 has acquired the batch exclusive lock or not. For example, the batch exclusive flag 27b holds value “on” when the batch exclusive lock control unit 25 has acquired the batch exclusive lock, whereas the batch exclusive flag 27b holds value “off” when the batch exclusive lock control unit 25 has not acquired the batch exclusive lock.

The batch exclusive waiting flag 27c represents whether there exists a processing unit among processing units (for example, the recognition processing unit 24 and the list obtainment processing unit 26) that has suspended acquirement of the batch exclusive lock. For example, when one of the recognition processing unit 24 and the list obtainment processing unit 26 has acquired the batch exclusive lock, the other one of the recognition processing unit 24 and the list obtainment processing unit 26 tries to acquire the batch exclusive lock. In this case, the batch exclusive waiting flag 27c is set at value “on”. On the other hand, when the other one of the recognition processing unit 24 and the list obtainment processing unit 26 which tried to acquire the batch exclusive lock has acquired the batch exclusive lock, the batch exclusive waiting flag 27c is set at value “off”.

The lock state storage unit 27d stores lock acquirement states of the device-basis exclusive lock and the batch exclusive lock acquired by the plurality of processing units (the I/O issuance processing unit 22, the recognition processing unit 24, and the list obtainment processing unit 26). For example, when both of the device-basis exclusive lock relative to the device 31 and the shared lock are acquired, the lock state storage unit 27d stores a lock acquirement state representing “shared lock+device-basis exclusive lock relative to device 31 acquired state”. When the device-basis exclusive locks relative to the devices 31 and 32 and the shared lock are simultaneously acquired, the lock state storage unit 27d stores a lock acquirement state representing “shared lock+device-basis exclusive lock relative to device 31+device-basis exclusive lock relative to device 32 acquired state”.

Here, as a method for storing the lock acquirement state of the lock state storage unit 27d, for example, flags of the devices 31 to 33 representing whether the device-basis exclusive lock has been acquired may be stored.

Next, processes performed by the device-basis exclusive lock control unit 23 and the execution unit 22a included in the I/O issuance processing unit 22 will be described. The lock acquisition availability determination unit 23a determines whether the device-basis exclusive lock is available when the I/O process assigning unit 21 assigns a request to the I/O issuance processing unit 22.

For example, the lock acquisition availability determination unit 23a refers to the batch exclusive waiting flag 27c included in the lock information storage unit 27, and determines whether the batch exclusive waiting flag 27c is set at value “off”. Then the lock acquisition availability determination unit 23a waits for a predetermined time period when the batch exclusive waiting flag 27c is set at value “on”, and thereafter, again determines whether the batch exclusive waiting flag 27c is set at value “off”.

On the other hand, the lock acquisition availability determination unit 23a refers to the batch exclusive flag 27b when the batch exclusive waiting flag 27c is set at value “off”. Then the lock acquisition availability determination unit 23a waits for a predetermined time period when the batch exclusive flag 27b is set at value “on”, and thereafter, again determines whether the batch exclusive flag 27b is set at value “off”. Further, the lock acquisition availability determination unit 23a refers to the lock state storage unit 27d when the batch exclusive flag 27b is set at value “off”. Then, the lock acquisition availability determination unit 23a determines whether the device-basis exclusive lock of one of the devices 31 to 33 which is a target of the I/O process performed in response to the request assigned to the I/O issuance processing unit 22 has been acquired.

When it is determined that the device-basis exclusive lock of one of the devices 31 to 33 which is the target of the I/O process performed in response to the request assigned to the I/O issuance processing unit 22 has been acquired, the lock acquisition availability determination unit 23a waits for a predetermined time period. Thereafter, the lock acquisition availability determination unit 23a refers to the lock state storage unit 27d, and determines again whether the device-basis exclusive lock of one of the devices 31 to 33 which is the target of the I/O process performed in response to the request assigned to the I/O issuance processing unit 22 has been acquired.

When it is determined that the device-basis exclusive lock of one of the devices 31 to 33 which is the target of the I/O process performed in response to the request assigned to the I/O issuance processing unit 22 has not been acquired, the lock acquisition availability determination unit 23a notifies the lock acquisition unit 23c of information representing that that device-basis exclusive lock is available.

Here, in the state where the batch exclusive flag 27b or the batch exclusive waiting flag 27c is set at value “on”, or the device-basis exclusive lock of one of the devices 31 to 33 which is the target of the I/O process has been acquired, when the lock acquisition availability determination unit 23a waits for a predetermined time period, the lock acquisition availability determination unit 23a also executes the following process. That is, the lock acquisition availability determination unit 23a notifies the lock state change unit 23b of information representing that the lock acquisition availability determination unit 23a waits for a predetermined time period. Further, when it is determined that the device-basis exclusive lock of one of the devices 31 to 33 which is the target of the I/O process performed in response to the request assigned to the I/O issuance processing unit 22 has not been acquired, the lock acquisition availability determination unit 23a notifies the lock state change unit 23b of information representing that the device-basis exclusive lock is available.

Upon receiving, from the lock acquisition availability determination unit 23a, the notification representing that the lock acquisition availability determination unit 23a waits for a predetermined time period, the lock state change unit 23b changes a state of one of the user programs 11 and 12 which has issued the I/O process request assigned to the I/O issuance processing unit 22, to a waiting state. The user program which has entered the waiting state turns into a busy loop state.

Upon receiving, from the lock acquisition availability determination unit 23a, the notification representing that the device-basis exclusive lock is available, the lock state change unit 23b cancels the waiting state of the user program and causes the information processing device 1 to execute the I/O process in response to the request issued by the user program.

Upon receiving, from the lock acquisition availability determination unit 23a, the notification representing that the device-basis exclusive lock is available, the lock acquisition unit 23c executes the following process. That is, the lock acquisition unit 23c increments by one the value of the share counter 27a included in the lock information storage unit 27.

Further, the lock acquisition unit 23c changes the lock acquirement state by rewriting the lock acquirement state stored in the lock state storage unit 27d. For example, the lock acquisition unit 23c adds information representing that the device-basis exclusive lock of one of the devices 31 to 33 which is the target of the I/O process has been acquired, to the lock acquisition state stored in the lock state storage unit 27d. Thereafter, the lock acquisition unit 23c notifies the execution unit 22a of the information representing that the device-basis exclusive lock has been acquired.

When the execution unit 22a terminates the I/O process, the lock acquisition unit 23c removes the information representing that the device-basis exclusive lock of one of the devices 31 to 33 which is the target of the I/O process has been acquired, from the lock state storage unit 27d, and decrements by one the value of the share counter 27a. That is, when the execution unit 22a terminates the I/O process, the lock acquisition unit 23c releases the device-basis exclusive lock of one of the devices 31 to 33 which is the target of the I/O process and the shared lock.

Upon receiving, from the lock acquisition unit 23c, the notification representing that the device-basis exclusive lock is acquired, the execution unit 22a executes the I/O process corresponding to the request assigned to the I/O issuance processing unit 22, that is, the I/O issuance process. In other words, the execution unit 22a executes the I/O issuance process on one of the devices 31 to 33 for which the lock acquisition unit 23c has acquired the device-basis exclusive lock.

Next, processes performed by the batch exclusive lock control unit 25 and the execution unit 24a included in the recognition processing unit 24 will be described. The lock acquisition availability determination unit 25a determines whether the batch exclusive lock is acquirable when the I/O process assigning unit 21 assigns an I/O process request to the recognition processing unit 24.

For example, the lock acquisition availability determination unit 25a refers to the share counter 27a, the batch exclusive flag 27b, the batch exclusive waiting flag 27c, and the lock state storage unit 27d included in the lock information storage unit 27, and determines whether the batch exclusive lock or the shared lock has been acquired. When it is determined that neither the batch exclusive lock nor the shared lock has been acquired, the lock acquisition availability determination unit 25a notifies the lock state change unit 25b and the lock acquisition unit 25c of information representing that the batch exclusive lock is available.

Meanwhile, when the shared lock has been acquired and the batch exclusive waiting flag 27c is set at value “off”, that is, when the batch exclusive lock has not been acquired but the device-basis exclusive lock has been acquired, the lock acquisition availability determination unit 25a executes the following process. That is, the lock acquisition availability determination unit 25a sets the batch exclusive waiting flag 27c at value “on” and waits for a predetermined time period. Thereafter, the lock acquisition availability determination unit 25a determines again whether the batch exclusive lock and the shared lock have been acquired.

When the shared lock has been acquired and the batch exclusive waiting flag 27c is set at value “on”, the lock acquisition availability determination unit 25a waits for the release of all shared locks. That is, the lock acquisition availability determination unit 25a waits for the completion of the following processes: all the shared locks are released; one of the recognition processing unit 24 and the list obtainment processing unit 26 which has suspended acquirement of the batch exclusive lock acquires the batch exclusive lock; and thereafter the batch exclusive lock is released. Then, after waiting for a predetermined time period, the lock acquisition availability determination unit 25a determines again whether the batch exclusive lock and the shared lock have been acquired or not.

When the batch exclusive lock has been acquired and the batch exclusive waiting flag 27c is set at value “off”, the lock acquisition availability determination unit 25a waits for the release of the batch exclusive lock. Thereafter, the lock acquisition availability determination unit 25a determines again whether the shared lock and the batch exclusive lock have been acquired or not.

Here, when the lock acquisition availability determination unit 25a waits for a predetermined time period, the lock acquisition availability determination unit 25a notifies the lock state change unit 25b of information representing that the lock acquisition availability determination unit 25a waits for the predetermined time period. In this case, as with the lock state change unit 23b, the lock state change unit 25b changes a state of one of the user programs 11 and 12 which has issued the I/O process request to the recognition processing unit 24, to a waiting state. Further, upon receiving, from the lock acquisition availability determination unit 25a, the notification representing that the batch exclusive lock is available, the lock state change unit 25b cancels the waiting state of the one of the user programs 11 and 12 and causes the information processing apparatus 1 to execute the I/O process in response to the request issued by the one of the user programs 11 and 12.

Upon receiving the notification representing that the batch exclusive lock is available from the lock acquisition availability determination unit 25a, the lock acquisition unit 25c executes the following process. That is, the lock acquisition unit 25c sets the batch exclusive flag 27b at value “on” and changes the lock acquirement state by rewriting the lock acquirement state stored in the lock state storage unit 27d.

For example, the lock acquisition unit 25c adds information representing that the batch exclusive lock has been acquired, to the lock acquisition state stored in the lock state storage unit 27d. Thereafter, the lock acquisition unit 25c notifies the execution unit 24a of the information representing that the batch exclusive lock has been acquired. Further, when the execution unit 24a terminates the I/O process, the lock acquisition unit 25c removes the information representing that the batch exclusive lock has been acquired, from the lock state storage unit 27d, and sets the batch exclusive flag 27b at value “off”. In other words, the lock acquisition unit 25c releases the batch exclusive lock.

Upon receiving the notification representing that the batch exclusive lock is acquired from the lock acquisition unit 25c, the execution unit 24a executes the I/O process for the request assigned to the recognition processing unit 24, that is, the process of recognizing the devices 31 to 33.

Note that the batch exclusive lock control unit 25 included in the list obtainment processing unit 26 has the same function as the batch exclusive lock control unit 25 included in the recognition processing unit 24. Further, an execution unit 26a obtains a list of the devices 31 to 33 which are common resources included in the hardware 30 when the batch exclusive lock control unit 25 acquires the batch exclusive lock. That is, the list obtainment processing unit 26 acquires the batch exclusive lock upon receiving an I/O process request from the I/O process assigning unit 21, and thereafter, executes the process of obtaining the list of the devices 31 to 33 which are the common resources included in the hardware 30.

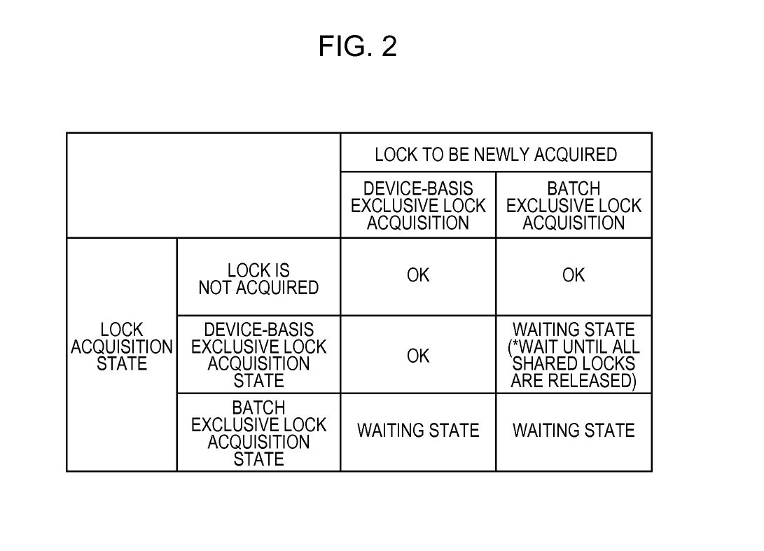

FIG. 2 is a diagram illustrating an example of a transition of lock acquisition states, according to an embodiment. Here, description will be given of a process of determining whether a lock is acquirable, which is performed by the device-basis exclusive lock control unit 23 and the batch exclusive lock control unit 25 in accordance with states of acquisition of the device-basis exclusive lock and the batch exclusive lock and a type of the lock newly acquired. In a description below, the device-basis exclusive lock control unit 23 and the batch exclusive lock control unit 25 will be also abbreviated as “lock control units 23 and 25”. Hereinafter, an access authority will be also expressed simply as a “lock”.

In the example illustrated in FIG. 2, the device-basis exclusive lock control unit 23 and the batch exclusive lock control unit 25 permit acquirement of the device-basis exclusive lock and the batch exclusive lock, respectively, when the batch exclusive lock and the device-basis exclusive lock have not been acquired. Further, when the device-basis exclusive lock for one of the device 31 to 33 has been acquired, the device-basis exclusive lock control unit 23 permits the acquirement of the device-basis exclusive lock for the other ones of the devices 31 to 33.

Meanwhile, the batch exclusive lock control unit 25 does not permit acquirement of the batch exclusive lock until all the shared locks are released, and causes one of the user programs 11 and 12 which has issued the I/O process request, to enter a waiting state. Further, when the batch exclusive lock has been acquired, the lock control units 23 and 25 do not permit acquirement of the device-basis exclusive lock or the batch exclusive lock, and cause one of the user programs 11 and 12 which has issued the request for performing an I/O process, to enter a waiting state.

Next, the relationships between types of locks that are obtained by the I/O issuance processing unit 22, the recognition processing unit 24, and the list obtainment processing unit 26 and the I/O processes that are executed by the I/O issuance processing unit 22, the recognition processing unit 24, and the list obtainment processing unit 26 will be described. For example, when content of the I/O process to be executed requires exclusiveness for all the devices 31 to 33, the I/O issuance processing unit 22, the recognition processing unit 24, and the list obtainment processing unit 26 acquire the batch exclusive lock for all the devices 31 to 33. On the other hand, when the content of the I/O process to be executed requires exclusiveness only for each of the devices 31 to 33 and a total time period needed for a plurality of I/O processes is reduced by executing an I/O process to be performed on a device in parallel with other I/O processes to be performed on the other devices of the devices, it is sufficient for each of the I/O issuance processing unit 22, the recognition processing unit 24, and the list obtainment processing unit 26, to acquire the device-basis exclusive lock.

Note that, an I/O process which requires exclusiveness for all the devices 31 to 33 means a process that is not able to accept change in a state of common resources during execution of the process. Examples of I/O processes which require exclusiveness for all the devices 31 to 33 include an identification process, a list obtainment process, and an error process. Examples of I/O processes which require exclusiveness for each of the devices 31 to 33 include an I/O interruption process and an I/O issuance process.

For reasons mentioned above, the recognition processing unit 24 and the list obtainment processing unit 26, which execute the processes requiring exclusiveness for all the devices 31 to 33, each include the batch exclusive lock control unit 25 that acquires the batch exclusive lock. On the other hand, the I/O issuance processing unit 22, which executes the process requiring exclusiveness for each of the devices 31 to 33, includes the device-basis exclusive lock control unit 23 that acquires the device-basis exclusive lock.

For example, the OS 20 illustrated in FIG. 1 determines whether the content of the I/O process requires exclusiveness for all the devices 31 to 33 using the I/O process assigning unit 21. When the content of the I/O process requires exclusiveness for all the devices 31 to 33, the OS 20 causes one of the recognition processing unit 24 and the list obtainment processing unit 26 which executes the I/O process, to acquire the batch exclusive lock. Further, when the content of the I/O process requires exclusiveness for each of the devices 31 to 33, the OS 20 causes the I/O issuance processing unit 22 which executes the I/O process, to acquire the device-basis exclusive lock. Then the OS 20 causes the I/O issuance processing unit 22, the recognition processing unit 24, or the list obtainment processing unit 26 which acquires the batch exclusive lock or the device-basis exclusive lock, to execute the I/O process.

Here, the OS 20 executes in parallel a plurality of I/O processes which have acquired device-basis exclusive locks. For example, when the user program 11 issues a request for performing the I/O issuance process relative to the device 31 and the user program 12 issues a request for performing the I/O interruption process relative to the device 32, the OS 20 causes each of the I/O issuance process and the I/O interruption process to acquire the device-basis exclusive lock.

As a result, the OS 20 may execute in parallel the I/O issuance process relative to the device 31 and the I/O interruption process relative to the device 32. In this way, when a plurality of requests for performing I/O processes which are executable in parallel are issued, the I/O processes may be executed in parallel without making the I/O processes wait, thereby improving system performance in a multiprocessor operation.

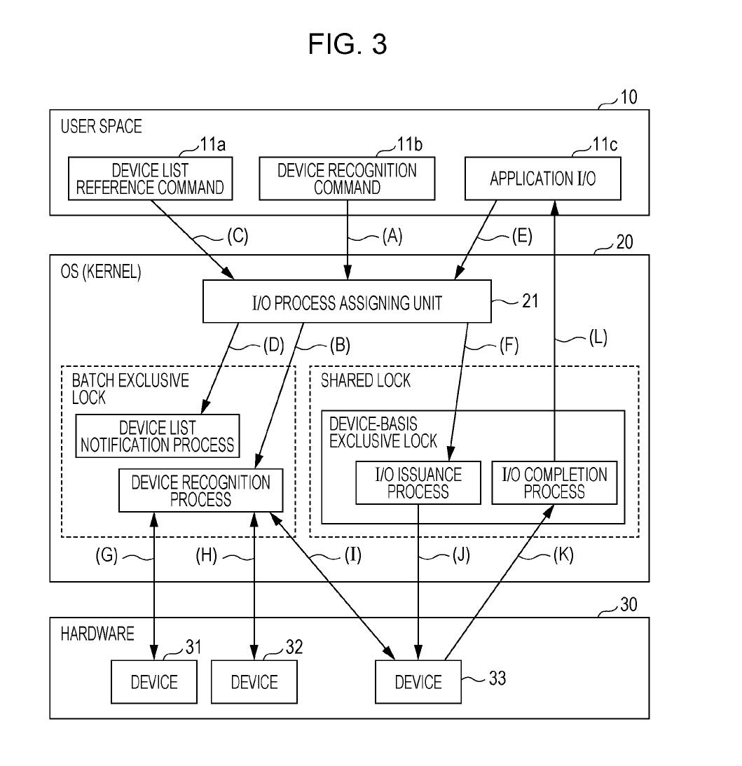

FIG. 3 is a diagram illustrating an example of assignment of an I/O process request, according to an embodiment. FIG. 3 illustrates a process of acquiring an access authority in association with content of an I/O process which is performed by the OS 20. In the example illustrated in FIG. 3, it is assumed that a device-list reference command 11a, a device recognition command 11b, and an application I/O 11c issue requests for performing various I/O processes.

For example, as illustrated by denotation (A) in FIG. 3, when the device recognition command 11b issues a request for performing the device recognition process, the I/O process assigning unit 21 assigns the request for performing the device recognition process to the recognition processing unit 24 and causes the recognition processing unit 24 to acquire the batch exclusive lock as illustrated by denotation (B) in FIG. 3. Further, when the device-list reference command 11a issues a request for performing a device-list notification process as illustrated by denotation (C) in FIG. 3, the I/O process assigning unit 21 executes the following process. That is, the I/O process assigning unit 21 assigns the request for performing the device-list notification process to the list obtainment processing unit 26 and causes the list obtainment processing unit 26 to acquire the batch exclusive lock as illustrated by denotation (D) in FIG. 3.

As illustrated by denotation (E) in FIG. 3, when the application I/O 11c issues a request for performing the I/O issuance process relative to the device 33, the I/O process assigning unit 21 assigns the request to the I/O issuance processing unit 22 as illustrated by denotation (F) in FIG. 3. In the case, the I/O process assigning unit 21 causes the I/O issuance processing unit 22 to acquire the device-basis exclusive lock in response to the request for an I/O issuance process.

After acquiring the batch exclusive lock, the recognition processing unit 24 executes the process of recognizing the devices 31 to 33 as illustrated by denotations (G) to (I) in FIG. 3. Here, since the recognition processing unit 24 has already acquired the batch exclusive lock, the list obtainment processing unit 26 enters a waiting state without executing the device-list notification process. Thereafter, when the recognition processing unit 24 terminates the process and releases the batch exclusive lock, the list obtainment processing unit 26 acquires the batch exclusive lock and executes the device-list notification process.

When the list obtainment processing unit 26 terminates the process and releases the batch exclusive lock, the I/O issuance processing unit 22 acquires the device-basis exclusive lock relative to the device 33 as illustrated by denotation (I) in FIG. 3. Then the I/O issuance processing unit 22 executes an I/O process relative to the device 33 as illustrated by denotation (3) in FIG. 3. Thereafter, when completing the I/O process relative to the device 33, the I/O issuance processing unit 22 executes an I/O completion process as an interruption as illustrated by denotation (K) in FIG. 3 and transmits a completion notification to the application I/O 11c as illustrated by denotation (L) in FIG. 3.

As mentioned above, when the request for the I/O process is issued, the OS 20 acquires the batch exclusive lock or the device-basis exclusive lock in accordance with the content of the I/O process. Then the OS 20 executes in parallel the I/O processes for which device-basis exclusive locks relative to respective different devices are acquired. Therefore, the OS 20 may execute the I/O processes relative to different devices in parallel.

Further, the OS 20 may appropriately acquire an access authority without adding, to a user program, a complicated function of executing a process of acquiring the device-basis exclusive lock relative to a device serving as a target of exclusion and a process of releasing the device-basis exclusive lock. For example, in order to add a function for acquiring and releasing a device-basis exclusive lock of a target of exclusion, along with the batch exclusive lock which is the giant lock, to a user program without generating a dead lock, details about order of acquisition of access authorities are need to be considered. However, since the OS 20 is configured to acquire an access authority in accordance with content of an I/O process issued by a user program, a modification of the user program may be unnecessary.

Here, a method for storing common resources which are access targets of I/O processes to be executed and for executing in parallel an I/O process for another common resource which does not compete against the common resources of the targets of the I/O processes may be considered. However, in this method, it is necessary to store common resources serving as targets of different I/O processes and to make determination whether competition occurs, thereby increasing processing cost. However, according to the embodiments, since the OS 20 simply acquires the batch exclusive lock which is the giant lock or the device-basis exclusive lock which is a lock for each device, in accordance with content of an I/O process, a plurality of executable I/O processes may be performed in parallel without performing a complicated process.

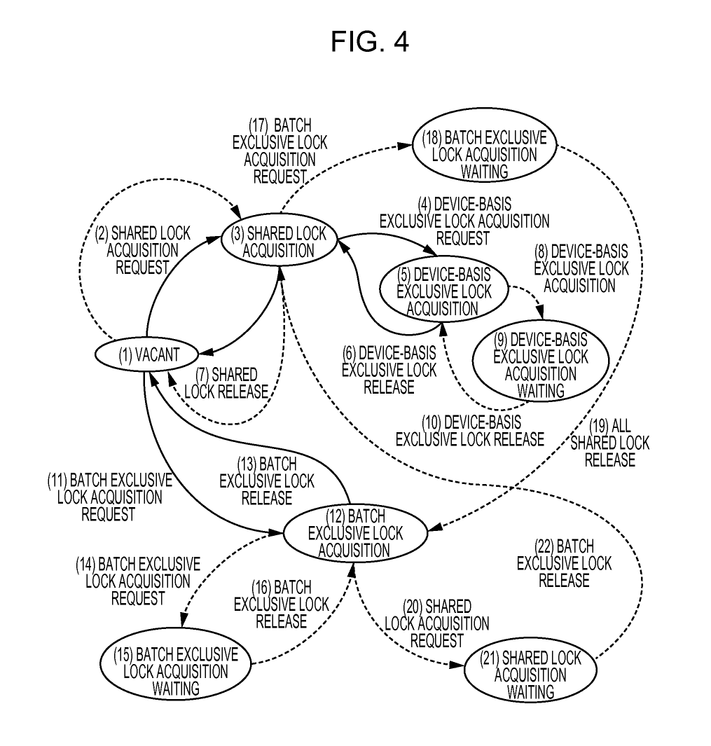

Further, the OS 20 may be easily implemented since resources for the general giant lock may be used as resources for the batch exclusive lock. Accordingly, considerations of competition among the batch exclusive lock, the shared lock, and the device-basis exclusive lock, and transition of a lock acquisition state suffice for implementation of the OS 20. Here, a lock acquisition state means a state of an access authority acquired. Hereinafter, an example of competition among the batch exclusive lock, the shared lock, and the device-basis exclusive lock and change of a lock acquisition state will be described with reference to FIG. 4.

FIG. 4 is a diagram illustrating an example of transition of a lock acquisition state, according to an embodiment. In FIG. 4, arrow marks of solid lines represent change of the lock acquisition state in a precedent process and arrow marks of dotted lines represent change of the lock acquisition state in a subsequent process. Since the batch exclusive lock, the shared lock, and the device-basis exclusive lock are not acquired in an initial state, the lock acquisition state is “vacant” as illustrated by denotation (1) in FIG. 4.

As illustrated by denotation (2) in FIG. 4, when the shared lock is requested in a lock acquisition state of “vacant”, a “shared lock acquisition” state is entered as illustrated by denotation (3) in FIG. 4. When acquisition of the device-basis exclusive lock is requested in a lock acquisition state of “shares lock acquisition” as illustrated by denotation (4) in FIG. 4, that is, when a request for performing an I/O process of acquiring the device-basis exclusive lock is issued, a “device-basis exclusive lock acquisition” state is entered as illustrated by denotation (5) in FIG. 4. Here, when the device-basis exclusive lock and the shared lock are released, the lock acquisition state becomes “vacant” again as illustrated by denotations (6) and (7) in FIG. 4.

On the other hand, when acquisition of the device-basis exclusive lock is requested in a lock acquisition state of “device-basis exclusive lock acquisition” as illustrated by denotation (8) in FIG. 4, a “device-basis exclusive lock acquisition waiting” state is entered as the lock acquisition state as illustrated by denotation (9) in FIG. 4. Thereafter, when the device-basis exclusive lock obtained in the precedent process is released, as illustrated by denotation (10) in FIG. 4, a “device-basis exclusive lock acquisition” state regarding a request in the subsequent process is entered as the lock acquisition state.

When acquisition of the batch exclusive lock is requested as illustrated by denotation (11) in FIG. 4 in a lock acquisition state of “vacant”, a “batch exclusive lock acquisition” state is entered as the lock acquisition state as illustrated by denotation (12) in FIG. 4. Further, when the batch exclusive lock is released as illustrated by denotation (13) in FIG. 4, the lock acquisition state becomes “vacant” as illustrated by denotation (1) in FIG. 4.

When acquisition of the batch exclusive lock is requested as illustrated by denotation (14) in FIG. 4 in a lock acquisition state of “batch exclusive lock acquisition”, a “batch exclusive lock acquisition waiting” state is entered as the lock acquisition state as illustrated by denotation (15) in FIG. 4. Thereafter, when the batch exclusive lock is released as illustrated by denotation (16) in FIG. 4, the lock acquisition state becomes the “batch exclusive lock acquisition” state as illustrated by denotation (12) in FIG. 4.

When acquisition of the batch exclusive lock is requested as illustrated by denotation (17) in FIG. 4 in a lock acquisition state of “shared lock acquisition”, a “batch exclusive lock acquisition waiting” state is entered as the lock acquisition state as illustrated by denotation (18) in FIG. 4. Thereafter, when all shared locks are released as illustrated by denotation (19) in FIG. 4, the lock acquisition state becomes the “batch exclusive lock acquisition” state as illustrated by denotation (12) in FIG. 4.

When acquisition of the shared lock is requested as illustrated by denotation (20) in FIG. 4 in a lock acquisition state of “batch exclusive lock acquisition”, a “shared lock acquisition waiting” state is entered as the lock acquisition state as illustrated by denotation (21) in FIG. 4. Further, when the batch exclusive lock is released as illustrated by denotation (22) in FIG. 4, the lock acquisition state becomes the “shared lock acquisition” state as illustrated by denotation (3) in FIG. 4.

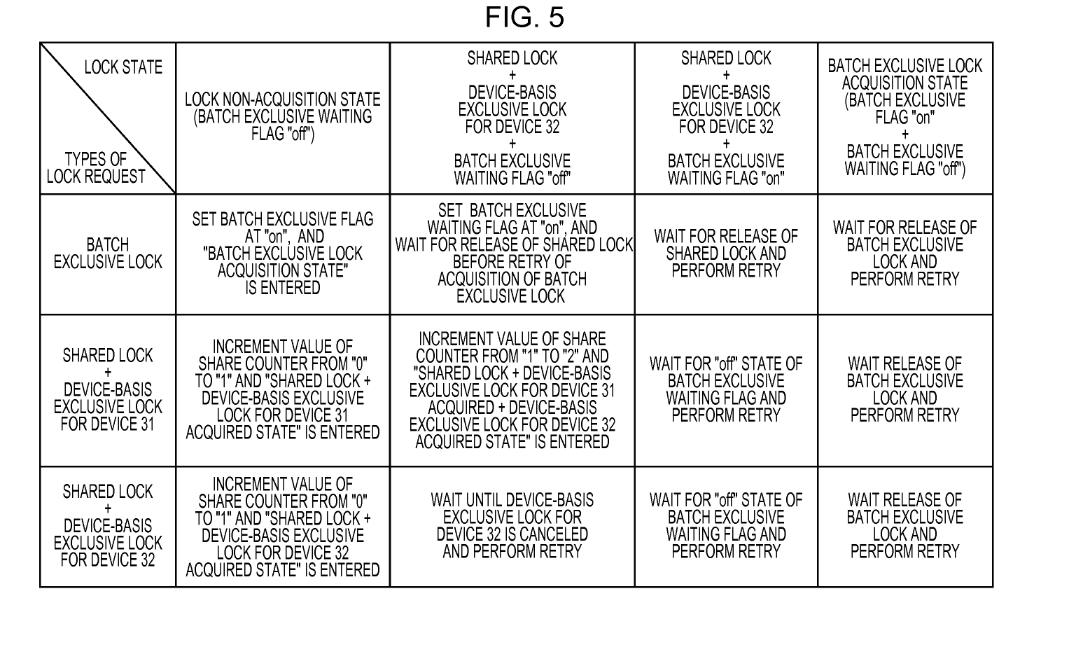

FIG. 5 is a diagram illustrating an example of transition of a lock acquisition state, according to an embodiment. FIG. 5 illustrates lock acquisition states newly obtained in accordance with the relationships between current lock acquisition states (axis of abscissa) and types of locks newly requested to be acquired (axis of ordinate).

For example, when the batch exclusive waiting flag 27c is set at value “off” in a lock non-acquisition state in which the batch exclusive lock and the device-basis exclusive lock are not acquired and acquisition of the batch exclusive lock is requested, the OS 20 sets the batch exclusive flag 27b at value “on” and causes a lock acquisition state to be a “batch exclusive lock acquisition state”.

Meanwhile, when acquisition of the shared lock and the device-basis exclusive lock relative to the device 31 is requested in a lock state where the batch exclusive lock and the device-basis exclusive lock have not been acquired, and the batch exclusive waiting flag 27c is set at value “off”, the OS 20 performs the following process. That is, the OS 20 increments the value of the share counter 27a from “0” to “1”, and sets a “shared lock+device-basis exclusive lock for device 31 acquired” state as a new lock state.

When acquisition of the shared lock and the device-basis exclusive lock relative to the device 32 are requested in a lock state where the batch exclusive lock and the device-basis exclusive lock have not been acquired, and the batch exclusive waiting flag 27c is set at value “off”, the OS 20 performs the following process. That is, the OS 20 increments the value of the share counter 27a from “0” to “1”, and sets a “shared lock+device-basis exclusive lock relative to device 32 acquired state” as a new lock state.

When acquisition of the batch exclusive lock is requested in a lock state where the shared lock and the device-basis exclusive lock relative to the device 32 are acquired and the batch exclusive waiting flag 27c is set at value “off”, the OS 20 performs the following process. That is, the OS 20 sets the batch exclusive waiting flag 27c at value “on”, and waits for release of the shared lock before retrying the acquisition of the batch exclusive lock.

When acquisition of the shared lock and the device-basis exclusive lock relative to the device 31 is requested in a clock state where the shared lock and the device-basis exclusive lock relative to the device 32 are acquired, and the batch exclusive waiting flag 27c is set at value “off”, the OS 20 performs the following process. That is, the OS 20 increments the value of the share counter 27a from “1” to “2”, and sets a “shared lock+device-basis exclusive lock relative to device 31 acquired+device-basis exclusive lock relative to device 32 acquired state” as a new lock state.

When acquisition of the shared lock and the device-basis exclusive lock for the device 32 is requested in a lock state where the shared lock and the device-basis exclusive lock relative to the device 32 are acquired, and the batch exclusive waiting flag 27c is set at value “off”, the OS 20 performs the following process. That is, the OS 20 waits until the device-basis exclusive lock relative to the device 32 is released, and thereafter the OS 20 retries acquisition of the device-basis exclusive lock relative to the device 32.

When acquisition of the batch exclusive lock is requested in a lock state where the shared lock and the device-basis exclusive lock relative to the device 32 are acquired, and the batch exclusive waiting flag 27c is set at value “on”, the OS 20 performs the following process. That is, the OS 20 waits for release of the shared lock, and thereafter retries the acquisition of the batch exclusive lock.

When acquisition of the shared lock and the device-basis exclusive lock relative to the device 31 is requested in a lock state where the shared lock and the device-basis exclusive lock relative to the device 32 are acquired, and the batch exclusive waiting flag 27c is set at value “on”, the OS 20 performs the following process. That is, the OS 20 waits until the batch exclusive waiting flag 27c is set at value “off”, and thereafter the OS 20 retries the acquisition of the shared lock and the device-basis exclusive lock relative to the device 31.

When the shared lock and the device-basis exclusive lock relative to the device 32 are acquired in a lock state where the batch exclusive waiting flag 27c is set at “on” and acquisition of the shared lock and the device-basis exclusive lock relative to the device 32 is requested, the OS 20 performs the following process. That is, the OS 20 waits until the batch exclusive waiting flag 27c is set at “off”, and thereafter retries the acquisition of the shared lock and the device-basis exclusive lock relative to the device 32.

When acquisition of the batch exclusive lock is requested in a lock state where the batch exclusive lock is acquired, that is, the batch exclusive waiting flag 27c is set at “on” and the batch exclusive waiting flag 27c is set at “off”, the OS 20 performs the following process. That is, the OS 20 waits for release of the batch exclusive lock, and thereafter retries the acquisition of the batch exclusive lock.

When acquisition of the shared lock and the device-basis exclusive lock relative to the device 31 is requested in a lock state where the batch exclusive lock is acquired, that is, the batch exclusive flag 27b is set at “on” and the batch exclusive waiting flag 27c is set at “off”, the OS 20 waits for release of the batch exclusive lock, and thereafter retries the acquisition of the requested lock.

Furthermore, when acquisition of the shared lock and the device-basis exclusive lock relative to the device 32 is requested in a lock state where the batch exclusive lock is acquired, that is, the batch exclusive flag 27b is set at “on” and the batch exclusive waiting flag 27c is set at “off”, the OS 20 waits for release of the batch exclusive lock, and thereafter retries the acquisition of the requested lock.

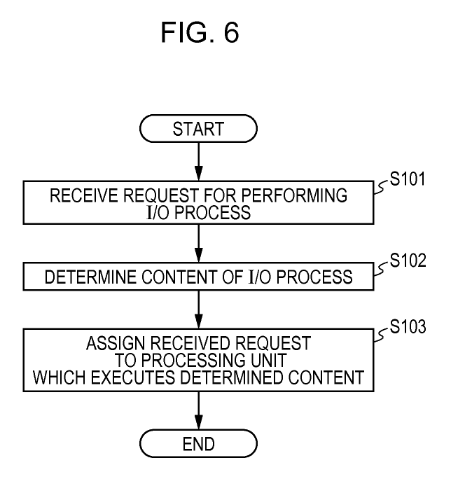

Next, examples of processes executed by the I/O process assigning unit 21, the device-basis exclusive lock control unit 23, and the batch exclusive lock control unit 25 will be described with reference to FIGS. 6 to 8.

FIG. 6 is a diagram illustrating an example of an operational flowchart for a request assigning process, according to a first embodiment. FIG. 6 illustrates an example of an operational flowchart for assigning a request in accordance with content of an I/O process which is performed by the OS 20.

In operation S101, the OS 20 receives a request for performing an I/O process issued by the user program 11 or the user program 12.

In operation S102, the OS 20 determines content of the I/O process to be executed.

In operation S103, the OS 20 assigns the request for performing the I/O process to one of the I/O issuance processing unit 22, the recognition processing unit 24, and the list obtainment processing unit 26 which executes the determined content of the I/O process, and terminates the request assigning process.

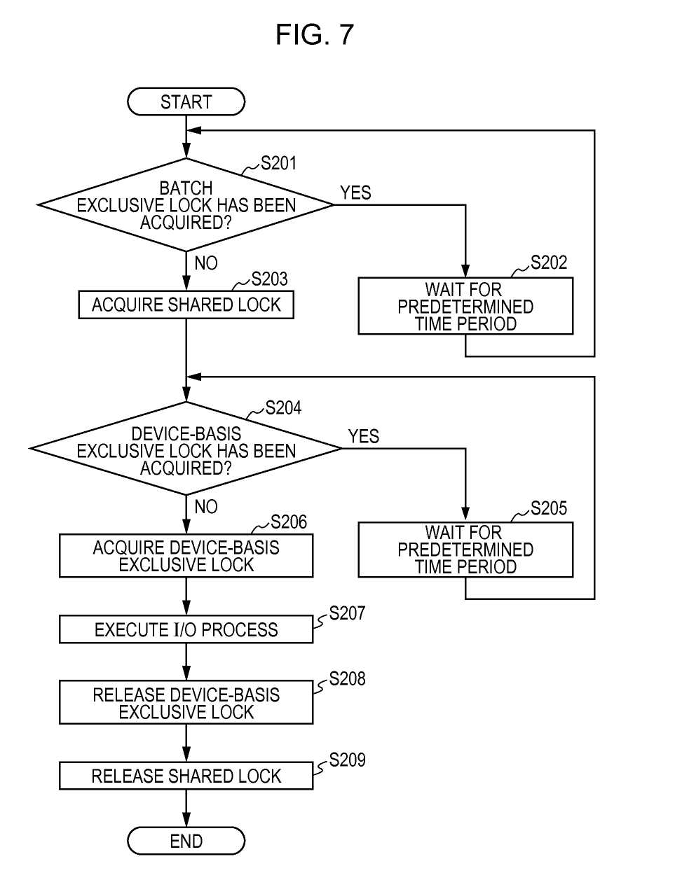

FIG. 7 is a diagram illustrating an example of an operational flowchart for acquiring a device-basis exclusive lock, according to a first embodiment. FIG. 7 illustrates an example of an operational flowchart for acquiring a device-basis exclusive lock using the device-basis exclusive lock control unit 23.

In operation S201, when a request for performing an I/O process is assigned to a processing unit such as the I/O issuance processing unit 22, the device-basis exclusive lock control unit 23 determines whether the batch exclusive lock has been acquired. When the batch exclusive lock has been acquired (YES in operation S201), the device-basis exclusive lock control unit 23 waits for a predetermined time period (in operation S202), and thereafter determines again whether the batch exclusive lock has been acquired (in operation S201).

On the other hand, when the batch exclusive lock has not been acquired (NO in operation S201), the device-basis exclusive lock control unit 23 acquires the shared lock (in operation S203).

In operation S204, the device-basis exclusive lock control unit 23 determines whether the device-basis exclusive lock for one of the devices 31 to 33 which is a target of the I/O process has been acquired. When the device-basis exclusive lock has been acquired (YES in operation S204), the device-basis exclusive lock control unit 23 waits for a predetermined time period (in operation S205), and thereafter determines again whether the device-basis exclusive lock has been acquired (in operation S204).

Meanwhile, when it is determined that the device-basis exclusive lock for one of the devices 31 to 33 which is the target of the I/O process has not been acquired yet (NO in operation S204), the device-basis exclusive lock control unit 23 acquires the device-basis exclusive lock for the one of the devices 31 to 33 which is the target of the I/O process (in operation S206).

In operation S207, the I/O process is executed.

In operation S208, the device-basis exclusive lock control unit 23 releases the acquired device-basis exclusive lock.

In operation S209, the device-basis exclusive lock control unit 23 releases the shared lock, and terminates the process.

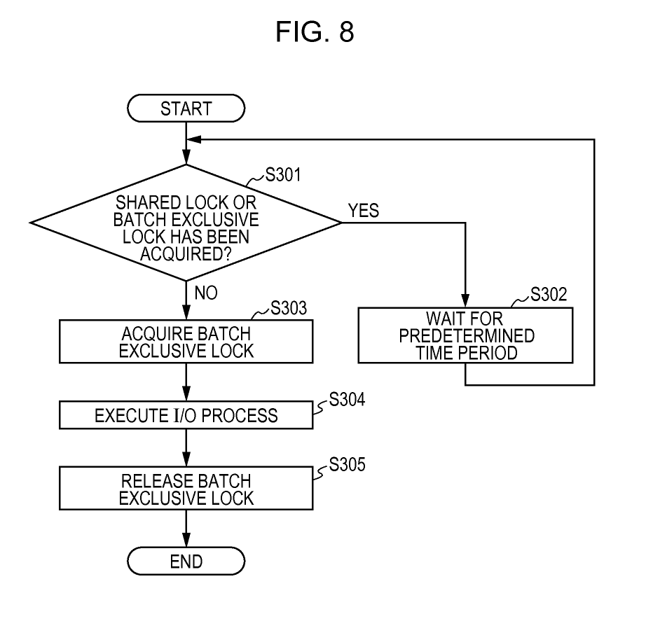

FIG. 8 is a diagram illustrating an example of an operational flowchart for obtaining a batch exclusive process, according to a first embodiment. FIG. 8 illustrates an example of an operational flowchart for acquiring a batch exclusive lock, which is performed by the batch exclusive lock control unit 25.

In operation S301, when a request for performing an I/O process is assigned to a processing unit which executes the I/O process such as the recognition processing unit 24, the batch exclusive lock control unit 25 determines whether the shared lock or the batch exclusive lock has been acquired. When it is determined that the shared lock or the batch exclusive lock has been acquired (YES in operation S301), the batch exclusive lock control unit 25 waits for a predetermined time period (in operation S302). Thereafter, the batch exclusive lock control unit 25 again determines whether the shared lock or the batch exclusive lock has been acquired again (in operation S301).

Meanwhile, when it is determined that neither the shared lock nor the batch exclusive lock has been acquired (NO in operation S301), the batch exclusive lock control unit 25 acquires the batch exclusive lock (in operation S303).

In operation S304, the I/O process is performed.

In operation S305, the batch exclusive lock control unit 25 releases the batch exclusive lock, and terminates the process.

### Effects of First Embodiment

As described above, the OS 20 includes a plurality of processing units: the I/O issuance processing unit 22, the recognition processing unit 24, and the list obtainment processing unit 26, which acquire the batch exclusive lock or the device-basis exclusive lock in accordance with content of an I/O process to be executed. When a request for performing an I/O process is issued, the OS 20 determines content of the I/O process to be executed and assigns the request regarding the determined content to one of the I/O issuance processing unit 22, the recognition processing unit 24, and the list obtainment processing unit 26. That is, when a request for an I/O process is issued, the OS 20 acquires the batch exclusive lock or the device-basis exclusive lock in accordance with the content of the I/O process.

Therefore, when a plurality of requests for performing I/O processes which are executable in parallel are issued, the OS 20 may simultaneously execute the I/O processes. Consequently, the OS 20 may improve the system performance in the multiprocessor operation.

For example, in a case where a conventional OS or the I/O issuance processing unit 22, the recognition processing unit 24, and the list obtainment processing unit 26 are virtualized, overhead occurs since instructions for the devices 31 to 33 included in the hardware 30 are emulated. Therefore, when the conventional OS, the I/O issuance processing unit 22, the recognition processing unit 24, and the list obtainment processing unit 26 are virtualized, a time period used to acquire the giant lock is increased.

Consequently, performance of an I/O process may be degraded each time the number of processing units is increased and the number of user programs simultaneously executed is increased. However, according to the embodiments, since the OS 20 is able to simultaneously execute a plurality of I/O processes which are executable in parallel, even when the number of processing units is increased, deterioration of performance of the I/O processes is avoided, and accordingly, the system performance may be improved.

Furthermore, a plurality of processing units included in the OS 20 (the I/O issuance processing unit 22, the recognition processing unit 24, and the list obtainment processing unit 26) acquire the batch exclusive lock when an I/O process to be executed requires exclusiveness for all the devices 31 to 33. Meanwhile, the plurality of processing units acquire the device-basis exclusive lock when I/O processes do not require the exclusiveness, that is, when I/O processes are executable in parallel. In other words, when content of an I/O process to be executed requires exclusiveness for all the devices 31 to 33, the OS 20 acquires the batch exclusive lock in response to the request for performing the I/O process, and otherwise, the OS 20 acquire the device-basis exclusive lock for one of the devices 31 to 33 which is a target of an I/O process.

Therefore, the OS 20 may acquire an access authority (or a lock) of a type corresponding to content of each I/O process without modifying the user programs 11 and 12 which issue a request for an I/O process. Consequently, the OS 20 may simultaneously perform a plurality of I/O processes which are executable in parallel without modifying the user programs 11 and 12.

Furthermore, when a request for performing the recognition process, the list obtainment process, or the error process is issued, the OS 20 acquires the batch exclusive lock, as an access authority, since these processes require exclusiveness for all the devices 31 to 33. As a result, the OS 20 avoids permission of an access of another I/O process while performing an error process, thereby allowing the OS 20 to appropriately execute the I/O process.

Further, the OS 20 waits for a predetermined time period when a request for an I/O process of acquiring the batch exclusive lock is newly issued in a state where the batch exclusive lock or the device-basis exclusive lock has been already acquired. Thereafter, when the batch exclusive lock or the device-basis exclusive lock has been released, the OS 20 causes the request for the I/O process newly issued to acquire the batch exclusive lock. Therefore, when a request for performing an I/O process of acquiring the batch exclusive lock is issued, the OS 20 may appropriately avoid competition against another request.

The OS 20 waits for a predetermined time period when a request for an I/O process of acquiring the device-basis exclusive lock for a device is newly issued in a state where the device-basis exclusive lock or the batch exclusive lock has been already acquired for the same device. Thereafter, when the device-basis exclusive lock or the batch exclusive lock for the same device has been released, the OS 20 causes the request for performing an I/O process newly issued to acquire the device-basis exclusive lock. Accordingly, when the request for performing an I/O process of acquiring the device-basis exclusive lock is issued, the OS 20 may appropriately avoid competition against another request.

### Second Embodiment

Various embodiments other than the foregoing embodiments may be made. Another embodiment included in the present technique will be described as a second embodiment hereinafter.

Embodiment of OS 20

The OS 20 described above include the plurality of processing units, i.e., the I/O issuance processing unit 22, the recognition processing unit 24, and the list obtainment processing unit 26, which perform predetermined I/O processes, and each of the I/O issuance processing unit 22, the recognition processing unit 24, and the list obtainment processing unit 26 includes the device-basis exclusive lock control unit 23 or the batch exclusive lock control unit 25, depending on content of the I/O process to be executed. However, the present technique is not limited to this. For example, an OS 20 may be configured to include one device-basis exclusive lock control unit 23 and one batch exclusive lock control unit 25.

In this case, when a request for performing an I/O process is issued, the OS 20 calls a function of the device-basis exclusive lock control unit 23 or a function of the batch exclusive lock control unit 25, depending on content of the I/O process, and causes the issued request to acquire a device-basis exclusive lock or a batch exclusive lock. Thereafter, the OS 20 may cause the issued requests to execute I/O processes in the order of acquiring the device-basis exclusive lock or the batch exclusive lock.

That is, when requests for performing I/O processes are issued, the OS 20 acquires the batch exclusive lock or the device-basis exclusive lock depending on content of the I/O processes, and performs an I/O process for a request that has firstly acquired one of the batch exclusive lock and the device-basis exclusive lock.

The I/O issuance processing unit 22, the recognition processing unit 24, and the list obtainment processing unit 26 may be operated as subroutines. When a request for performing an I/O process is issued, the OS 20 calls one of subroutines which executes the request in accordance with content of the I/O process. For example, when a request for performing an I/O issuance process is issued, the OS 20 calls the I/O issuance processing unit 22 as the subroutine. Then the I/O issuance processing unit 22 calls the device-basis exclusive lock control unit 23 as a subroutine and acquires the device-basis exclusive lock before executing the I/O issuance process.

The embodiments may be implemented as an exclusive control program including an I/O process assigning unit 21, the device-basis exclusive lock control unit 23, and the batch exclusive lock control unit 25 in addition to the OS 20 described in the first embodiment. The OS 20 and the exclusive control program may be realized by executing programs prepared in advance using a computer such as a personal computer or a work station. The programs may be distributed through a network such as the Internet. Furthermore, the programs are recorded in a computer-readable recording medium such as a hard disk, a flexible disk (FD), a CD-ROM (Compact Disc Read Only Memory), an MO (Magneto Optical Disc), or a DVD (Digital Versatile Disc). Furthermore, the program may be executed by being read from the recording medium using the computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer readable recording medium having stored therein a program for causing a computer to execute a procedure, the computer being included in an information-processing apparatus performing a plurality of processes, the procedure comprising:
a content-determination process determining content of I/O processing requested by an I/O processing request that has been issued, by one of the plurality of processes, to access common resources including a plurality of devices shared by the plurality of processes; and
a resource-acquisition process causing the I/O processing request to acquire one of first and second access authorities depending on the determined content of the I/O processing, the first access authority permitting only one I/O processing request at a time to access the common resources, the second access authority permitting only one I/O processing request at a time to access one of the plurality of devices included in the common resource.

2. The computer readable recording medium of claim 1, wherein
the content-determination process includes determining whether the content of the I/O processing requires exclusiveness for the common resources; and
the resource-acquisition process includes:
causing the I/O processing request to acquire the first access authority when it is determined that the content of the I/O processing requires exclusiveness for the common resources, and
causing the I/O processing request to acquire the second access authority when it is determined that the content of the I/O processing does not require exclusiveness for the common resources.

3. The computer readable recording medium of claim 2, wherein
it is determined that the content of the I/O processing requires exclusiveness for the common resources when the determined content of the I/O processing indicates one of device identification processing, device-list acquisition processing, and error recovery processing, the device identification processing identifying a device included in the common resources, the device-list acquisition processing acquiring a list of all devices included in the common resources, the error recovery processing being performed on a device included in the common resources when an error has occurred on the device.

4. The computer readable recording medium of claim 1, wherein
the resource-acquisition process includes:
determining whether the first or second access authority has been acquired by another I/O processing request;
causing the I/O processing request to be awaited when the first or second access authority has been allocated to the another I/O processing request; and
causing the I/O processing request to acquire the first access authority when the first access authority is released from the another I/O processing and all the second access authorities are released.

5. The computer readable recording medium of claim 1, wherein
the resource-acquisition process includes:
determining whether the first access authority or the second access authority over a device requested by the I/O processing request has been allocated to another I/O processing request; and
causing the I/O processing request to be awaited when the first access authority or the second access authority over a device requested by the I/O processing request has been allocated to another I/O processing request; and
causing the I/O processing request to acquire the second access authority when the first and second access authorities has been released.

6. An apparatus comprising:
an I/O processing assigning unit configured to determine content of I/O processing requested by an I/O processing request that has been issued, by one of a plurality of processes, to access common resources including a plurality of devices shared by the plurality of processes; and
an exclusive lock control unit configured to cause the I/O processing request to acquire one of first and second access authorities depending on the determined content of the I/O processing, the first access authority permitting only one I/O processing request at a time to access the common resources, the second access authority permitting only one I/O processing request at a time to access one of the plurality of devices included in the common resource.

7. A method comprising:
determining content of I/O processing requested by an I/O processing request that has been issued, by one of a plurality of processes, to access common resources including a plurality of devices shared by the plurality of processes; and
causing the I/O processing request to acquire one of first and second access authorities depending on the determined content of the I/O processing, the first access authority permitting only one I/O processing request at a time to access the common resources, the second access authority permitting only one I/O processing request at a time to access one of the plurality of devices included in the common resource.
